(19) United States
(12) Patent Application Publication
(10) Pub. No.: US 2009/0030579 A1
(43) Pub. Date: Jan. 29, 2009

(54) VEHICLE DOOR CONTROLLER

(75) Inventor: Satoshi TAKEHISA, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/177,549

(22) Filed: Jul. 22, 2008

(30) Foreign Application Priority Data
Jul. 23, 2007 (JP) 2007-191147

(51) Int. Cl. E05F 15/20

(52) U.S. Cl. 701/49

(57) ABSTRACT

When a reservation signal is received from a portable device, an ECU of a vehicle-side controller detects whether a user is present near a door. When it is detected that the user is present near the door, the ECU of the vehicle-side controller transmits a door unlock command signal and a door opening command signal to the door drive control section for unlocking the lock mechanism of the door. The door drive control section drives a motor of the lock mechanism to unlock the door and also open the door the door unlock command signal and the door opening command signal have been received.

### CROSS-REFERENCE TO RELATED APPLICATIONS

The present application is based on and claims priority to Japanese Patent Application No. 2007-191147 filed on Jul. 23, 2007, the entire contents of which are incorporated herein by reference.

### BACKGROUND OF THE INVENTION

1. Field of the Invention

The present invention relates to a vehicle door controller and, more specifically, to a controller that automatically opens a vehicle door.

2. Description of the Related Art

When carrying baggage or other objects destined for the interior of the vehicle with both hands, an unassisted vehicle user ordinarily has to complete many steps in order to accomplish the objective. First, the user must carry the baggage to the vicinity of the vehicle, lay the baggage down, open or raise a backdoor with one hand, and pick up, carry and lift the baggage again for loading. It therefore may be troublesome to load a vehicle with baggage when the freedom of movement of both hands is restrained.

An example of a vehicle door controller that automatically opens a vehicle door is known from an automatic opening and closing system for a power backdoor for a vehicle as described for example, in JP2005-307692A.

The system in JP2005-307692 is arranged in a rear pillar for a vehicle and is provided with two touch sensors for detecting a backdoor opening/closing demand operation of a driver to convert the operation into an electrical signal for the outputting, a control section for determining whether to open or close a vehicular backdoor based upon the electrical signal inputted from the touch sensor, and a backdoor opener that receives the determination result of the control section to open/close the vehicular backdoor. When the user touches the two touch sensors in an order of the touch sensor of the ground side first and then the touch sensor of the ceiling side second, the control section is arranged to assume that the user has an intention of opening the backdoor.

However, disadvantages arise in that, even thought automatic opening and closing is facilitated, the user needs to touch two touch sensors, causing possible complications in the event that the bags or other objects are heavy and unwieldy. By requiring touching two buttons, the user may struggle and potentially damage the vehicle surface with the bag or object, or damage the object itself while attempting to execute proper button press sequence.

### SUMMARY OF THE INVENTION

The present invention has been made in view of the foregoing and therefore an object is to provide a vehicle door controller that can automatically open a vehicle door when a user comes near a vehicle.

In order to achieve the above and other objects, a vehicle door controller according to a first aspect is provided with a vehicle-side controller mounted in a vehicle and a command device in wireless communication with the vehicle-side controller. In response to an operation of a user, the command device transmits a reservation signal from outside the vehicle to the vehicle-side controller for making a reservation of automatic opening of a vehicle door. The vehicle-side controller is provided with first communication means for receiving the reservation signal transmitted from the command device, user detecting means for detecting whether a user exists near the vehicle door, and drive control means that, in a case where the first communication means receives the reservation signal, opens the vehicle door when the user detecting means detects that the user exists near the vehicle door.

The reservation signal is transmitted in advance. When the presence of the user is detected near the vehicle door, the vehicle door opens. Thus, even if a user carries baggage with both hands, the vehicle door is automatically opened in response to when the user approaches for loading the vehicle with the baggage without the need for performing any other operation.

According to a second aspect, the user detecting means includes second communication means that forms a communication area in the area around the vehicle and carries out communication in the communication area. The command device transmits a response signal including an ID code in response to a request signal transmitted from the second communication means. When the second communication means receives the response signal, the user detecting means determines that the user exists near the vehicle door by checking the ID code included in the response signal with a registration code registered in advance. If the ID code and the registration code satisfy a predetermined corresponding relation, the user is determined to be near the vehicle. If the ID code and the registration code do not satisfy the predetermined corresponding relation, the user is determined not to exist near the vehicle door.

At present, so-called smart entry systems, passive entry systems or intelligent key systems are known in which a request signal is transmitted from a vehicle-side unit and a portable key that transmits a response signal including an ID code in response to the request signal. In such systems, the vehicle-side unit checks the ID code included in the response signal with a registration code registered in advance to perform a predetermined control when the ID code and the registration code satisfy a predetermined corresponding relation. A second aspect is arranged to detect whether the user exists near the vehicle door by using such a system and it is possible to accurately detect whether the user exists near the vehicle door with the construction of the second aspect. Further, in a case where a vehicle mounts such a system, it can be detected whether the user exists near the vehicle door without addition of special components, leading to reduction in costs.

According to a third aspect, the user detecting means may start transmission of the request signal by the second communication means when the first communication means receives the reservation signal. Since the request signal can be efficiently transmitted, the consumption power can be reduced.

Further, according to a fourth aspect, user detecting means transmits the request signal in a predetermined time interval by the second communication means. When the reservation signal is received by the first communication means, the communication area by the second communication means may be broadened. Even if the user is at a distance from the vehicle, the user can be detected and the vehicle door can be opened before the user comes too close to the vehicle.

In addition, according to a fifth aspect, the user detecting means may include imaging means for image capture the area around the vehicle door. It may be detected whether the user exists near the vehicle door by recognizing the user by using an image photographed by the imaging means.

In recent years, the number of vehicles mounting a camera for antitheft monitoring and image capture of the area around a vehicle has increased. Therefore, according to the fifth aspect, it can be detected whether the user exists near the vehicle door without use of a special device, leading to reduction in costs.

Further, according to a sixth aspect, when the user detecting means receives the reservation signal, image capture by imaging means may start. Since the image capture by the imaging means can be efficiently made, the consumption power can be reduced.

According to a seventh aspect, if the vehicle is provided with a plurality of vehicle doors, the user detecting means detects that one of the plurality of the vehicle doors is nearest to the user and the drive control means opens the nearest vehicle door at an appropriate position relative to the user.

According to an eighth aspect, if the vehicle is provided with a backdoor as the vehicle door and plural rows of seats, the vehicle-side controller is provided with seat drive means that moves the backmost row of the seat to a sitting state and a storing state when the drive control means opens the backdoor. The user can thereby more easily load the vehicle with baggage.

According to a ninth aspect, the vehicle door controller further includes determining means that determines whether the backmost row of the seat is capable of being made to the storing state, wherein, in a case of moving the backmost row of the seat to the storing state, the seat drive means stores the backmost row of the seat determined to be capable of being made to the storing state by the determining means and stops the movement of the backmost row of the seat determined to be not capable of being made to the storing state by the determining means. For example, when there is baggage on or in front of the backmost row of the seat such as in or around the foot area, the baggage possibly blocks the movement of the backmost row of the seat. When an attempt is made to forcibly move the backmost row of the seat in such a state, the seat drive means or the baggage may be damaged. Therefore, according to the ninth aspect, forcible movement of the backmost row of the seat can be restricted, thus preventing the damage of the baggage or the backmost row of the seat.

According to a tenth aspect, when the determining means determines that the backmost row of the seat can not be placed in the storing state, the vehicle door controller may further include first notification means that provides a notification that the backmost row of the seat can not be moved. It is thereby possible to notify the user that the movement of the backmost row of the seat has stopped. Further, when the baggage is near the backmost row of the seat or on or in front of the backmost row of the seat, it is possible to prompt the user to move the baggage.

According to an eleventh aspect, when the drive control means opens the vehicle door, the vehicle door controller may further include second notification means that provides a notification that the vehicle door is opening. It is thereby possible to alert persons in the area around the vehicle of the opening of the vehicle door.

According to a twelfth aspect, the vehicle door controller may further include obstacle detecting means that detects an obstacle near the vehicle door allowing the drive control means to stop the opening of the vehicle door when an obstacle is detected during opening. It is thereby possible to prevent the vehicle door making contact with the obstacle.

According to a thirteenth aspect, when the obstacle detecting means detects an obstacle and the drive control means stops the opening of the vehicle door, the vehicle door controller may further include third notification means that provides a notification that the opening of the vehicle door stops. It is thereby possible to alert the user that the opening of the vehicle door is stopped.

According to a fourteenth aspect, the vehicle-side controller may include state signal transmitting means that transmits a state signal showing the automatic door opening state during opening the vehicle door when the user exists near the vehicle door. The command device may include output means that outputs the state signal transmitted from the communication means. It is thereby possible to inform the user of the state of the vehicle door.

### BRIEF DESCRIPTION OF THE DRAWINGS

Other objects, features, and advantages will become more apparent from the following detailed description made with reference to the accompanying drawings, in which like portions are designated by like reference numbers and in which:

FIG. 1 is a block diagram illustrating a vehicle door controller in an exemplary embodiment; and

FIG. 2 is a flow chart illustrating an exemplary process order in the vehicle door controller in an exemplary embodiment.

### DETAILED DESCRIPTION OF THE EXEMPLARY EMBODIMENTS

Hereinafter, a vehicle door controller in accordance with an exemplary embodiment will be explained with reference to the drawings.

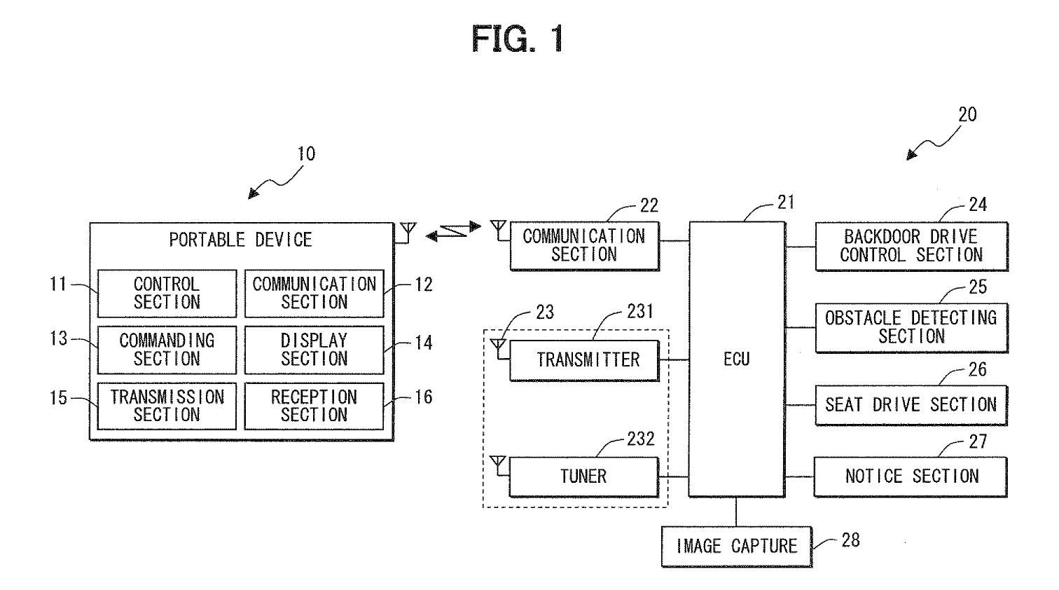

As shown in FIG. 1, the vehicle door controller of the present embodiment is provided with a portable device 10 that can carry out wireless communication and a vehicle-side controller 20. The portable device 10 is used as a key and further acts as a command device for a vehicle. More specifically the portable device 10 is a smart key in a system such as a so-called smart entry system, passive entry system, intelligent key system, and the like, that performs a given control such as for example, lock/unlock control of the vehicle door, based upon the checking result of the ID code by interactive mutual communication with the vehicle-side controller 20, including a transmitter 231 and a tuner 232, mounted in the vehicle.

The portable device 10 can include a control section 11 that includes a central processing unit (CPU), a memory, and the like, for performing a general control of the portable device 10, a portable device-side communication section 12 that carries out a wireless communication with a vehicle-side communication section 22 in the vehicle-side controller 20, a command section 13 operated, for example, by a user to command transmission of a reservation signal, a display section 14 including a liquid crystal display showing desired information, and the like.

The portable device 10 is provided with a transmission section 15 and a reception section 16 that carry out a mutual communication such as an interactive communication with the vehicle-side controller 20. Further, when the portable device 10 receives a request signal from the transmitter 231 of the vehicle-side controller 20 at the reception section 16, the portable device 10 transmits a response signal including the ID code from the transmitter 15 in response to the request signal. It should be noted that the ID code is stored in the memory.

The reservation signal provides a command including a reservation of the automatic door opening of the vehicle door to the vehicle-side controller 20. More specifically, the reservation signal commands an electronic control unit (ECU) 21 of the vehicle-side controller 20 in advance in such a manner that the vehicle door automatically opens in a case where a user comes close to the vehicle including, for example, when the user gets in the vehicle.

As described above, when a user carries baggage with both hands to load the baggage in the vehicle, several steps must be undertaken since the freedom of movement of both hands is restrained. The user must first lay down the baggage, raise a backdoor by opening the door with a free hand, and carry and lift the baggage again for loading. However, when the reservation signal transmitted in advance, it is possible to automatically open the vehicle door by coming into proximity to the vehicle without performing any other operation. Therefore, in such a situation, the vehicle can be loaded with the baggage without the need for putting the baggage on the ground to raise the backdoor. It should be noted that the processing operation of the vehicle-side controller 20 based upon the reservation signal will be described in greater detail hereinafter.

In the present embodiment, an example of transmitting the reservation signal by a smart key such as the portable device 10 is described as one example of the command device, but the present invention is not limited to such an example. For example, the reservation signal can be transmitted by a device having a wireless connection to the vehicle-side communication section 22 in the vehicle-side controller 20 from an outside of the vehicle such as a personal computer, a mobile phone, a personal digital assistant (PDA), or the like.

The vehicle-side controller 20 includes the ECU 21, the vehicle-side communication section 22 acting as first communication means, the user detecting section 23, the transmitter 231 acting as second communication section, the tuner 232 acting as second communication means, the backdoor drive control section 24, the obstacle detecting section 25, the seat drive section 26, the notice section 27 and the like. The ECU 21 includes the CPU and the memory for performing a general control of the vehicle-side controller 20.

The vehicle-side communication section 22 acts as the first communication means and carries out wireless communication with the portable device-side communication section 12 to output the received signal, such as the reservation signal, to the ECU 21.

The user detecting section 23 includes the transmitter 231 acting as second communication means and the tuner 232 acting as second communication means, that form a communication area in the area around the vehicle and carry out communication in the communication area.

The transmitter 231 is provided in each of a plurality of vehicle doors of the vehicle and transmits a request signal, for example, for each predetermined time based upon a command from the ECU 21. A reach distance of the request signal of the transmitter 231 is set in the order of 0.7 to 1.0 m, for example. That is, the user detecting section 23 forms a communication area, such as a detection area, in the surroundings of each door in the vehicle in accordance with the reach distance of the request signal.

The tuner 232 is provided in the vehicle compartment, receives the response signal transmitted from the portable device 10 in response to the request signal and outputs the received response signal to the ECU 21.

In addition, the ECU 21 checks the ID code included in the response signal outputted from the tuner 232 with the registration code stored in the memory. When it is determined that the corresponding relation between the ID code and the registration code is satisfied, the ECU 21 performs a predetermined control such as, for example, lock/unlock control of the vehicle door. Further, the ECU 21, acting as user detecting means, detects that a user of the portable device 10 comes close to each vehicle door of the vehicle by checking the ID code with the registration code. In addition, the ECU 21 is arranged to open the vehicle door based upon the reservation signal transmitted from the portable device-side communication section 12 and the aforementioned checking result. It should be noted that the processing operation of the ECU 21 will be explained in greater detail hereinafter.

The backdoor drive control section 24 is provided with a drive unit (not shown) such as a motor of a lock mechanism of the backdoor (not shown) as a part of the vehicle door and a motor for driving the backdoor and a control unit for controlling the drive unit. The backdoor drive control section 24 locks/unlocks the backdoor based upon a drive signal such as a backdoor unlock command signal or backdoor opening command signal, from the ECU 21 and automatically opens the backdoor by rotating the backdoor from a fully closed position to a fully opened position. The obstacle detecting section 25 is provided in the backdoor and for example, detects an obstacle behind the vehicle by an ultrasonic sensor to output the detection signal to the ECU 21.

The seat drive section 26 acts as seat drive means. The seat drive section 26 is provided with a motor and drives the backmost row such as, for example, the third row of seats into movement based upon a drive signal such as a storage command signal of the third row of seats, from the ECU 21. The seat drive section 26, for example, folds down a backrest of the third row seat and moves the seat to a storage position inside the floor in such a manner as to make a floor be in a flat state. In addition, the seat drive section 26 moves the third row seat located in the storage position to the sitting position where a user can sit and also sets the backrest of the seat to an upright state. The seat drive section 26 stores positions of the folded state and the upright state of the backrest of the seat and the storage position and the sitting position of the seat and drives the third row seat of the vehicle based upon the drive signal from the ECU 21.

The notice section 27 is provided with a speaker to output a sound based upon a command signal from the ECU 21.

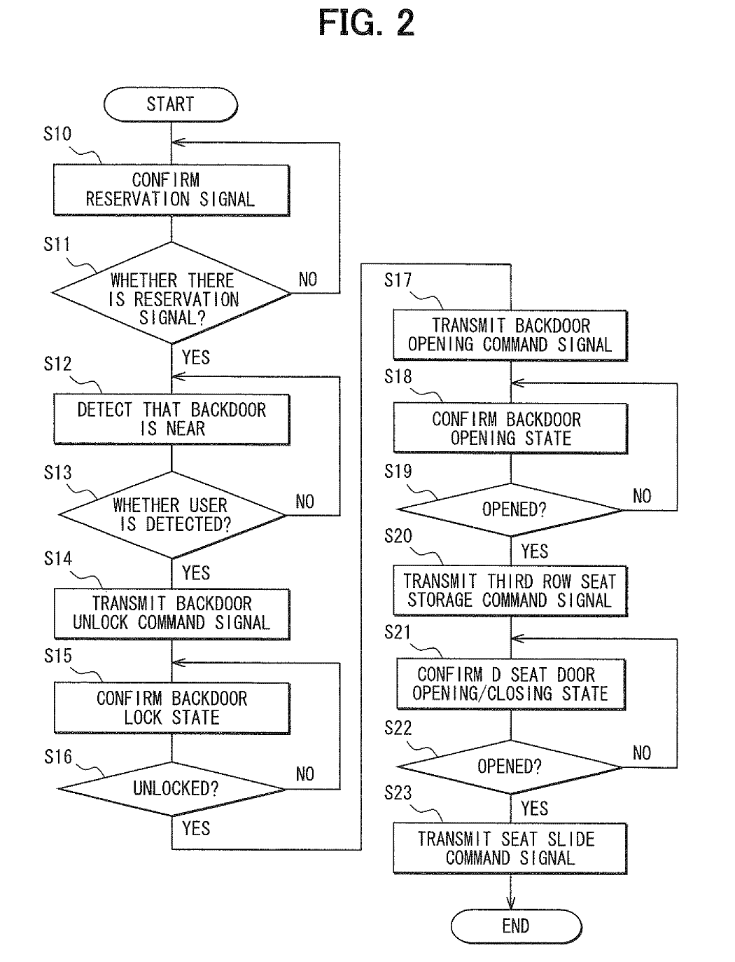

Here, the processing operation of the vehicle door controller in the present embodiment will be explained. FIG. 2 is a flow chart showing the processing operation of the vehicle door controller in the present embodiment. The flow chart shown in FIG. 2 is carried out in the middle of supplying power to the vehicle-side controller 20.

At S10, the ECU 21 confirms reception of a reservation signal from the portable device 10 at the vehicle-side communication section 22 acting as first communication means. In addition, at S11, the ECU 21 determines whether the reservation signal is received. When it is determined that the reservation signal is received, the process proceeds to S12. When it is determined that the reservation signal is not received, the process at S10 is repeated. The control section 11 in the portable device 10, acting as command device-side communication means, transmits the reservation signal from the portable device-side communication section 12 when the command section 13 acting as operating means is operated by the user.

At S12, the ECU 21, acting as user detecting means, detects whether a user comes close to or otherwise is present near the backdoor based upon whether a response signal from the portable device 10 is received at the tuner 232 in response to a request signal from the transmitter 231 provided in the backdoor.

It should be noted that in a case of transmitting a request signal by the transmitter 231, the ECU 21 may command the transmitter 231 in such a manner as to transmit the request signal in a predetermined time interval. When the reservation signal is received at the vehicle-side communication section 22, the ECU 21 may command the transmitter 231 in such a manner as to enlarge the communication area by the transmitter 231. That is, the ECU 21 may expand the reach distance of the request signal by commanding an increase in the output power by the transmitter 231. In a case of automatically opening the vehicle door such as the backdoor, when a user comes too close to the vehicle, the backdoor may come into contact with the user However, in the above described manner, it is possible to detect the user at a position even farther away from the vehicle and open the vehicle door before the user comes too close to the vehicle.

The ECU 21 may start transmission of the request signal at the transmitter 231 when the reservation signal is received at the vehicle-side communication section 22 and since the request signal can be efficiently transmitted, the consumption power can be reduced.

Further, when the ECU 21 receives the reservation signal, such as in a case where the backdoor is in an automatic door opening state of opening the backdoor when the user exists near the backdoor, the ECU 21, acting as state signal transmission means, transmits a state signal showing the automatic door opening state at the vehicle-side communication section 22, making it possible to alert the user of the state of the vehicle door.

At S13, the ECU 21 determines whether the presence of the user is detected. When it is determined that the presence of the user is detected, the process proceeds to S14. When it is determined that the user is not detected, the process returns to S12. It should be noted that, when the processes at S12 and S13 are repeated for a predetermined time, that is, when the determination of “NO” continues to be repeated for the predetermined time as the determination result at S13, the received reservation signal may be cancelled and the process returned to S10.

At S14, the ECU 21 transmits a backdoor unlock command signal to the backdoor drive control section 24 for unlocking a lock mechanism of the backdoor. When the backdoor unlock command signal is received, the backdoor drive control section 24 unlocks the backdoor by driving the motor of the lock mechanism.

At S15, the ECU 21 confirms the lock state of the backdoor. That is, the ECU 21 confirms whether the backdoor is unlocked at the backdoor drive control section 24. At S16, the ECU 21 determines whether the backdoor is unlocked based upon the result at S15. When it is determined that the backdoor is unlocked, the process proceeds to S17. When it is determined that the backdoor is not unlocked, the process returns to S15.

At S17, the ECU 21 transmits a backdoor opening command signal to the backdoor drive control section 24 for opening the backdoor. When the backdoor opening command signal is received, the backdoor drive control section 24, acting as drive control means, opens the backdoor by driving the motor associated with operating the backdoor.

In a case of automatically opening the backdoor at the backdoor drive control section 24, the ECU 21, acting as second notification means, may notify opening the backdoor through the notice section 27, making it possible to alert a person in the area surroundings of the backdoor of the opening of the backdoor.

In a case of automatically opening the backdoor, an obstacle near the vehicle door may be detected at the obstacle detecting section 25, acting as obstacle detecting means. Further, when an obstacle is detected by the obstacle detecting section 25 or when it is detected that the backdoor gets in contact with the obstacle, the ECU 21, acting as drive control means, transmits a stop signal to the backdoor drive control section 24. When the backdoor drive control section 24 receives the stop signal, the backdoor drive control section 24, acting as drive control means, stops a drive of a motor for driving the backdoor to stop the opening of the backdoor. As a result, it is possible to prevent the backdoor from coming into contact with the obstacle.

According to a thirteenth aspect, when the obstacle detecting means detects an obstacle and the drive control means stops the opening of the vehicle door, there may be further provided third notification means that provides a notification that the opening of the vehicle door is stopped.

In addition, in a case where the obstacle detecting section 25 thus detects the obstacle near the vehicle door, when the obstacle is detected, the ECU 21 may notify a user of stopping the opening of the backdoor by the notification means 27, acting as the third notification means. It is thereby possible to notify a user of stopping the opening of the backdoor.

At S18, the ECU 21 confirms a state of the backdoor. Specifically, the ECU 21 confirms whether the backdoor is opened or nor opened through the backdoor drive control section 24. At S19, the ECU 21 confirms whether the backdoor is opened based upon the result at S18. When it is determined that the backdoor is opened, the process proceeds to S20. When it is determined that the backdoor is not opened, the process returns to S18.

At S20, the ECU 21 transmits a storage command signal of the third row seat to the seat drive section 26 for making the third row seat be in a storage state. The seat drive section 26 that has received the storage command signal of the third row seat drives the motor to fold down the backrest and also moves the third row seat to the storage position inside the floor. A user can more easily load a vehicle with baggage by setting the third row seat to the storage state.

Further, a determining section may be provided that includes a camera for image capture in the area around the third row seat. Since well understood, such a determining section including a camera is referred to generally herein as the image capture unit 28, which in various embodiments can capture images from inside the vehicle, outside the vehicle, and from around the vehicle or from the inside, the outside and around the vehicle and, for example, with ECU 21, make determinations. The determining section can determine whether it is possible to place the third row seat in the storage state based upon the image captured by the camera. When the determining section determines that the third row seat can be placed in the storage state, the ECU 21 may transmit the storage command signal of the third row seat to the seat drive section 26. When the determining section determines that the third row seat can not be placed in the storage state, the ECU 21 may stop the transmission of the storage command signal of the third row seat to the seat drive section 26 in order to stop movement of the third row seat. Thus, the image capture unit 28 operating independently or in connection with other devices such as sensors for movement or current condition can constitute determining means.

For example, in a case where baggage is present on or in front of the third row seat in the foot placement area, the baggage may interrupt and obstruct the movement of the third row seat. When the third row seat is forcibly moved in an obstructed state, the seat drive section 26 such as, for example, a motor, or the baggage may be damaged. Therefore, by stopping or restricting the forcible movement of the third row seat as described above, it is possible to prevent damage of the baggage or of the third row seat and associated driving mechanism.

Further, in a case where the determining section determines that the third row seat can not be placed into the storage state, the ECU 21 may notify that the third row seat can not be moved by the notice section 27, acting as first notification means. It is thereby possible to alert a user that the movement of the third row seat has been stopped. In addition, when the baggage is on or in front of the third row seat, a user can be prompted to move the baggage.

At S21, the ECU 21 confirms an opening/closing state of a driver (D) seat by using a door curtain (not shown). At S22, when the ECU 21 determines that the door is opened, the process proceeds to S23. When the ECU 21 determines that the door is not opened, the process returns to S21.

At S23, the ECU 21 transmits a seat slide command signal, which is a drive signal, to the seat control section (not shown) for commanding the D seat to the backward direction of the vehicle opposite of the forward direction. The seat control section of the D seat drives a motor based upon a drive signal from the ECU 21 to move the D seat to the backward direction of the vehicle. It should be noted that the processes from S20 to S23 may be omitted.

In such a way, the reservation signal is transmitted in advance from the portable device 10. When it is detected that the user exists near the vehicle door such as a backdoor, the vehicle door is automatically opened, thus making it possible to automatically open the vehicle door based on the proximity of the user to the vehicle. Even if the use carries baggage with both hands, for example, the vehicle door is automatically opened and therefore, the user can load the vehicle with the baggage without performing any other operation.

At present, the known so-called smart entry system, passive entry system or intelligent key system use a request signal is transmitted from a vehicle-side unit and a portable key transmits a response signal including an ID code in response to the request signal. In the known systems, the vehicle-side unit checks the ID code included in the response signal with the registration code registered in advance to perform a predetermined control operation such as, for example, a lock/unlock control of the vehicle door when the ID code and the registration code satisfy a predetermined corresponding relation. In contrast, in the present embodiment, the presence of a user carrying the portable device 10 near a vehicle door of the vehicle is detected by using such a known system. That is, the ECU 21 detects that the user of the portable device 10 comes close to a vehicle door of the vehicle by checking between the ID code included in the response signal outputted from the tuner 232 and the registration code stored in the memory. Thereby, the addition of a special component is not necessary, leading to reduction in costs.

It should be noted that the present embodiment is described herein above using an example of detecting whether a user exists near the backdoor and automatically opening the backdoor based upon the detection result, but it will be appreciated that the present invention is not limited to such an embodiment and may be applied to any vehicle door mounted in a vehicle.

In addition, with regard to a plurality of vehicle doors mounted in a vehicle, the one of the vehicle doors to which a user is nearest is detected. Based upon the detection result, the vehicle door nearest the user may be opened. For example, the ECU 21 determines which of the transmitters 231 mounted in the respective vehicle doors the response signal received at the tuner 232 is transmitted in response to. Then, the ECU 21, acting as the drive control means, transmits a command signal to the door drive control section of the corresponding vehicle door for commanding the opening of the vehicle door and the vehicle door at an appropriate position can be opened.

Further, the present embodiment is described herein above in connection with an example using the mutual communication between the portable device 10 and the vehicle-side controller 20 as the means that detects whether a user exists near the vehicle door, but the present invention is not limited to such a configuration. For example, the presence of a user near a vehicle door may be detected using a camera that captures an image around the vehicle door. In such a case, the ECU 21 identifies the user by checking image data captured by the camera, for example, using pre-stored image data of the user retrieved from memory. In recent years, the number of vehicles that mount a camera for image capture the area around a vehicle for the purpose of antitheft has increased. Since well understood as described above, such a camera is referred to generally herein as the image capture unit 28. Therefore, the above described embodiment can be realized without use of a special device. Further, in a case of using a camera for image capture in the area around a vehicle door to detect the presence of a user, when the reservation signal is received at the vehicle-side communication section 22, as previously described herein, the ECU 21 may start the image capture by the camera. It is thereby possible to more efficiently begin image capture by the camera, leading to reduction in power consumption.

While selected exemplary embodiments have been discussed herein for illustration only to provide an understanding of the invention, it will be apparent to those skilled in the art from the present disclosure that various changes and modifications can be made without departing from the scope thereof. Furthermore, the foregoing description of the exemplary embodiments is not intended to limit the scope invention as defined with particularity by the appended claims and their equivalents.

What is claimed is:

1. A vehicle door controller provided with a vehicle-side controller mounted in a vehicle and a command device in wireless communication with the vehicle-side controller, the command device transmitting a reservation signal to the vehicle-side controller from an outside of the vehicle for making a reservation of automatic opening of one of a plurality of vehicle doors in response to an operation of the command device, the vehicle door controller comprising:
first communication means for receiving the reservation signal transmitted from the command device;
user detecting means for detecting that a user is present near the one of the plurality of vehicle doors; and
drive control means for opening the one of the plurality of vehicle doors when the first communication means has received the reservation signal and the user detecting means detects that the user is present near the one of the plurality of vehicle doors.

2. A vehicle door controller according to claim 1, wherein:
the user detecting means includes second communication means for forming a communication area around the vehicle, the second communication means for carrying out communication in the communication area;
the command device transmits a response signal including an ID code to the second communication means in response to a request signal transmitted from the second communication means;
the user detecting means checks the ID code included in the response signal with a registration code registered in advance; and
if the ID code and the registration code satisfy a predetermined corresponding relation, the user detection means determines that the user is present near the one of the plurality of vehicle doors, and if the ID code and the registration code do not satisfy the predetermined corresponding relation, the user detection means determines that the user is not present near the one of the plurality of vehicle doors.

3. A vehicle door controller according to claim 2, wherein:
the user detecting means starts transmission of the request signal using the second communication means when the first communication means receives the reservation signal.

4. A vehicle door controller according to claim 2, wherein:
the user detecting means transmits the request signal using the second communication means during a predetermined time interval; and
when the reservation signal is received by the first communication means, the communication area formed by the second communication means is increased.

5. A vehicle door controller according to claim 1, wherein:
the user detecting means includes imaging means that captures an image in an area around the one of the plurality of vehicle doors; and
the user detecting means detects that the user is present near the one of the plurality of vehicle doors by recognizing the user based on the captured image.

6. A vehicle door controller according to claim 5, wherein when the capture of the image by the imaging means is started when the user detecting means receives the reservation signal.

7. A vehicle door controller according to claim 1, wherein:
the one of the plurality of vehicle doors includes a backdoor;
the vehicle includes plural rows of seats; and
the vehicle-side controller includes seat drive means for moving a backmost row of the plural rows of seats between a sitting state and a storing state, the seat drive means moving the backmost row of the seat to the storing state when the drive control means opens the backdoor.

8. A vehicle door controller according to claim 7, further comprising:
determining means that determines whether the backmost row of the of the plural rows of seats is capable of being moved to the storing state,
wherein:
the backmost row of the of the plural rows of seats is moved to the storing state when it is determined to be capable of being moved to the storing state; and
the backmost row of the of the plural rows of seats is stopped from being moved when it is determined not to be capable of being moved to the storing state.

9. A vehicle door controller according to claim 8, further comprising:
notification means for providing a notification that the backmost row of the plural rows of seats is not capable of being moved to the storing state.

10. A vehicle door controller according to claim 1, further comprising:
notification means for providing a notification that the one of the plurality of vehicle doors opens when the drive control means opens the one of the plurality of vehicle doors.

11. A vehicle door controller according to claim 1, further comprising:
obstacle detecting means that detects an obstacle near the one of the plurality of vehicle doors, wherein:
the drive control means stops the opening of the one of the plurality of vehicle doors when the obstacle detecting means detects the obstacle.

12. A vehicle door controller according to claim 11, further comprising:
notification means for providing a notification that the opening of the one of the plurality of vehicle doors has stopped when the obstacle detecting means detects the obstacle and the drive control means stops the opening of the one of the plurality of vehicle doors.

13. A vehicle door controller according to claim 1, wherein:
the vehicle-side controller includes state signal transmitting means for transmitting a state signal showing the automatic door opening state of opening the one of the plurality of vehicle doors when it is detected that the user is present near the one of the plurality of vehicle doors; and
the command device includes output means that outputs the state signal transmitted from the communication means.
